(19) United States
(12) Patent Application Publication
(10) Pub. No.: US 2024/0308500 A1
(43) Pub. Date: Sep. 19, 2024

(54) AUTONOMOUS VEHICLE PARKING USING HIGH-DEFINITION MAPS

(71) Applicant: GM Cruise Holdings LLC, San Francisco, CA (US)

(72) Inventors: Anisha Mocherla, Chicago, IL (US); Michael Rusignola, Burlingame, CA (US); Kevin Zhang, San Francisco, CA (US)

(21) Appl. No.: 18/185,277

(22) Filed: Mar. 16, 2023

(51) Int. Cl. B60W 30/06; B60W 60/00

(52) U.S. Cl. CPC B60W 30/06; B60W 60/001; B60W 2556/40

(57) ABSTRACT

Aspects of the disclosed technology provide solutions for facilitating parking maneuvers performed by an autonomous vehicle (AV). In some aspects, the disclosed technology can include a method that includes steps for receiving a notification that the AV needs to be parked in a physical parking area, defining a first parking polygon and a parking pose in a virtual model that corresponds to the physical parking area, assigning the first parking polygon to the AV, and instructing the AV to navigate to the first parking polygon and assume the parking pose within the first parking polygon. Systems and machine-readable media are also provided.

### BACKGROUND

### 1. Technical Field

The present disclosure generally relates to autonomous navigation and, more specifically, parking of an autonomous vehicle (AV).

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning obstacle avoidance, and parking.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and do not limit the scope of the present technology to these examples. Furthermore, the skilled artisan will appreciate the principles of the present technology as described and explained with additional specificity and detail through the use of the accompanying drawings.

FIG. 1 depicts a conventional parking lot with statically defined parking spaces, according to some examples of the present disclosure;

FIG. 2 illustrates a virtual model of a parking area with statically defined parking spaces, according to some examples of the present disclosure;

FIG. 3 illustrates an example system environment that can be used to facilitate AV operations, according to some aspects of the disclosed technology;

FIG. 4 illustrates an exemplary workflow for managing parking of an AV, according to some aspects of the disclosed technology;

FIG. 5 depicts an exemplary parking area with dynamically defined parking spaces, according to some examples of the present disclosure;

FIG. 6 illustrates a virtual model of a parking area with dynamically defined parking spaces, according to some examples of the present disclosure;

FIG. 7 illustrates attributes of a parking polygon, according to some examples of the present disclosure; and

FIGS. 8-9 illustrate pose attributes of a vehicle within a parking polygon, according to some examples of the present disclosure.

### DETAILED DESCRIPTION

Autonomous vehicles (AVs), like any vehicle, require regular service and maintenance. Managing a fleet of AVs, for example a fleet of autonomous taxis, requires that each of the AVs periodically be brought to a site for refueling, cleaning, repair, and/or out-of-service storage. A site will have a parking area. Once an AV arrives at the parking area, it is necessary to determine where each AV is to be parked within the parking area and provide instructions and information to an AV as to where to park and how to traverse the site to reach that site. The systems and methods disclosed herein are directed to automatically managing a parking area for AVs using a site controller.

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

### Definitions

As used within this document, the term “parking” means an AV traveling to a selected location for logistical/maintenance activities.

As used within this document, the phrase “parking space” means a physical location having a size and shape suitable for parking an AV. A parking space has an associated boundary, e.g., defined by stripes or curbs.

As used within this document, the phrase “virtual model” means a virtual map and associated information, e.g., boundaries of a parking area, geometric polygons for AVs, parking polygons defined in the parking area, assignment of parking polygons to AVs, and information about AVs parked in the parking area, e.g., time since arrival, whether certain service activities have been completed, and state of charge of the AV.

As used within this document, the phrase “geometric polygon” means a virtual space defined in the virtual model and having a size and shape sufficient to accommodate a virtual model of an AV. Each type of AV has an associated geometric polygon.

As used within this document, the phrase “parking polygon” means a virtual area having a location and orientation within the virtual model. A parking polygon assigned to a particular AV can be based on the geometric polygon associated with that AV.

As used within this document, the term “pose” means one or more of: a position of an AV within a parking polygon, an orientation of an AV within a parking polygon, and/or a separation between the AV and the boundary of the parking polygon. The pose of an AV may be defined with respect to a “center” or other reference point of the AV or a perimeter feature of the AV. In some instances, pose can refer to an orientation of an AV with respect to any reference frame of the surrounding environment, for example, that may not be associated with a given parking polygon.

As used within this document, the phrase “travel path” means a path defined in the virtual model that an AV can traverse. A travel path may have origin and destination points. In certain embodiments, a portion of the travel path is statically defined and corresponds to static physical features of the parking area. In certain embodiments, a portion of the travel path is dynamically defined. An AV determines its current location in the virtual model and navigates through the parking area by replicating its physical motion, as determined by sensor on the AV, in the virtual model and controlling its physical motion so as to cause the virtual location of the AV to move along a travel path in the virtual model.

As used within this document, the term “thruness” is an attribute of a parking polygon as to whether the parking polygon has more than one portal through which an AV can enter or exit the parking polygon. In certain embodiments, a rectangular parking polygon having thruness will have two portals, e.g., an entrance and an exit.

As used within this document, the phrase “thru space” means a parking polygon that has thruness. In certain embodiments, the thru space has an entrance and an exit on opposite sides of the boundary.

As used within this document, the term “notification” means a message that is received from another system component; for example an AV or a sensor disposed proximate to an entrance location of a parking area. A notification comprises one or more of detection of an AV, an image of the AV, identification of the AV, and information associated with the AV.

One challenge in maintaining a fleet of autonomous vehicles (AVs) is that during periods of non-use, such as during servicing and/or maintenance, the AVs need to be parked in physical parking lots. Unlike the public roadways typically navigated by AVs, parking lots, such as outdoor lots or indoor garages, are often unstructured physical spaces through which AVs need to be navigated and arranged to optimize efficiencies of physical space, and maintenance accommodations. The arrangement of vehicles in a parking lot is also constrained by ingress and egress constraints, as well as the fleet maintenance concerns.

Aspects of the disclosed technology provide solutions for facilitating the autonomous arrangement of A Vs in physical parking lots. In some aspects, navigation and arrangement of AVs into selecting parking spaces (or stalls) can be facilitated using a map (also referred to herein as a high-resolution map, or HD map) that represents the locations, boundaries, and relative arrangements of various stall locations in a physical lot. As discussed in further detail below, the navigation and arrangement of AVs into indicated stalls can be facilitated through the use of HD maps that can include, or that may be linked to, AV pose information for each respective stall.

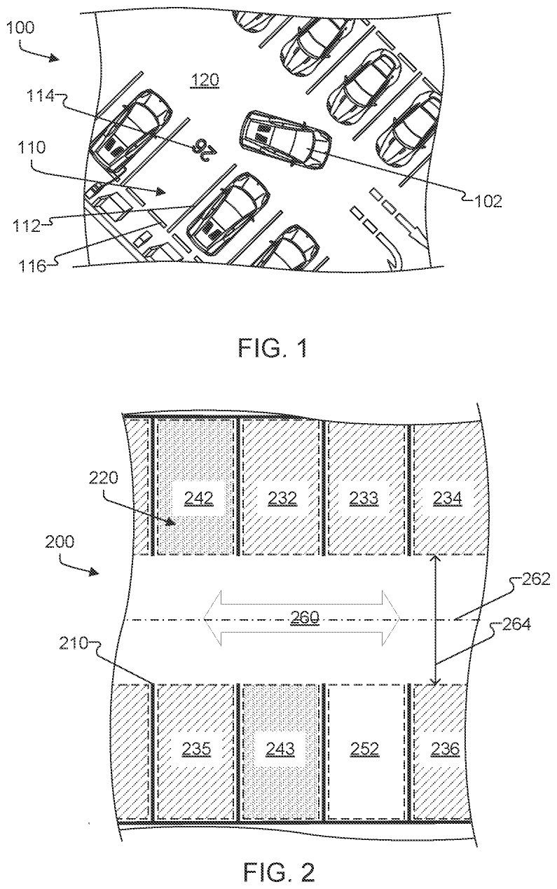

FIG. 1 depicts a conventional parking lot 100 with statically defined parking spaces, according to some examples of the present disclosure. Parking spaces 110 are permanently defined by stripes 112 and alphanumeric identifiers 114. Parking spaces 110 are typically intended to be entered by a vehicle 102 from a single side. Parking spaces are usually of uniform size and shape, although some parking spaces can have variations in size and shape, e.g., a “compact” space with smaller dimensions or a “handicap” space with larger dimensions to provide better access to the doors of the vehicle parked therein.

In some instances, movement through the opposing boundary side is prevented by wheel stops 116 or similar physical barrier. Access by vehicles 102 to parking spaces 110 is provided by an aisle 120.

FIG. 2 illustrates a virtual model 200 of a parking area with statically defined parking spaces, according to some examples of the present disclosure. Parking polygons 220 are defined in the virtual model 200 with fixed locations and orientations. In certain embodiments, the virtual model 200 includes delineators 210 that replicate the strips 112 of the physical parking lot. In certain embodiments, the parking polygons 220 are of a uniform size and shape, defined by a border. In certain embodiments, the parking polygons 220 are rectangular. In certain embodiments, the parking polygons 220 have a plurality of sizes and/or shapes so as to provide parking for a variety of vehicles.

A travel path 260 is defined in the virtual model 200 to replicate the aisle 120 of the physical parking lot. In certain embodiments, the travel path 260 has a centerline 262 and a width 264. In certain embodiments, the width 264 varies along the centerline 262.

In certain embodiments, the virtual model 200 includes attributes of the parking polygons 220. For example, the parking polygons 232, 233, 234, 235, and 236 (shown as crosshatched in FIG. 2) have vehicles parked therein, while parking polygon 242 and 243 (shown as shaded in FIG. 2) are empty. When an AV is assigned to a parking polygon 220, for example parking polygon 252 in FIG. 2, that assignment is recorded in the virtual model 200.

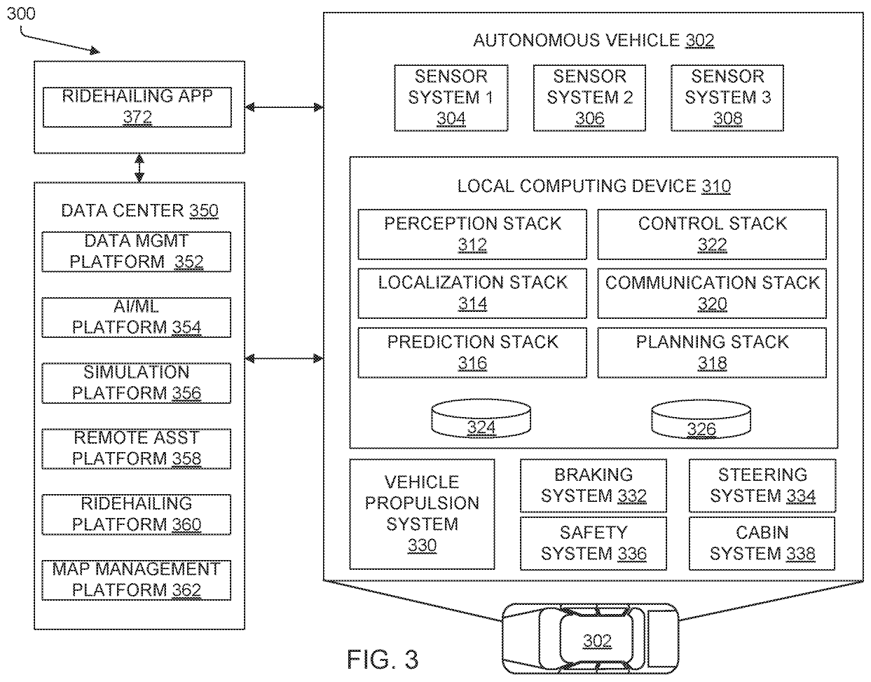

FIG. 3 illustrates an example system environment that can be used to facilitate AV operations, according to some aspects of the disclosed technology. One of ordinary skill in the art will understand that, for AV environment 300 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 300 includes an AV 302, a data center 350, and a client computing device 370. The AV 302, the data center 350, and the client computing device 370 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 302 can navigate roadways without a human driver based on sensor signals generated by multiple sensor systems 304, 306, and 308. The sensor systems 304-308 can include one or more types of sensors and can be arranged about the AV 302. For instance, the sensor systems 304-308 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 304 can be a camera system, the sensor system 306 can be a LIDAR system, and the sensor system 308 can be a RADAR system. Other examples may include any other number and type of sensors.

The AV 302 can also include several mechanical systems that can be used to maneuver or operate the AV 302. For instance, mechanical systems can include a vehicle propulsion system 330, a braking system 332, a steering system 334, a safety system 336, and a cabin system 338, among other systems. The vehicle propulsion system 330 can include an electric motor, an internal combustion engine, or both. The braking system 332 can include an engine brake, brake pads, actuators, and/or any other suitable componentry configured to assist in decelerating the AV 302. The steering system 334 can include suitable componentry configured to control the direction of movement of the AV 302 during navigation. The safety system 336 can include lights and signal indicators, a parking brake, airbags, and so forth. The cabin system 338 can include cabin temperature control systems, in-cabin entertainment systems, and so forth. In some examples, the AV 302 might not include human driver actuators (e.g., steering wheel, handbrake, foot brake pedal, foot accelerator pedal, turn signal lever, window wipers, etc.) for controlling the AV 302. Instead, the cabin system 338 can include one or more client interfaces (e.g., Graphical User Interfaces (GUIs), Voice User Interfaces (VUIs), etc.) for controlling certain aspects of the mechanical systems 330-338.

The AV 302 can include a local computing device 310 that is in communication with the sensor systems 304-308, the mechanical systems 330-338, the data center 350, and the client computing device 370, among other systems. The local computing device 310 can include one or more processors and memory, including instructions that can be executed by the one or more processors. The instructions can make up one or more software stacks or components responsible for controlling the AV 302; communicating with the data center 350, the client computing device 370, and other systems; receiving inputs from riders, passengers, and other entities within the AV's environment; logging metrics collected by the sensor systems 304-308; and so forth. In this example, the local computing device 310 includes a perception stack 312, a localization stack 314, a prediction stack 316, a planning stack 318, a communications stack 320, a control stack 322, an AV operational database 324, and an HD geospatial database 326, among other stacks and systems.

Perception stack 312 can enable the AV 302 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 304-308, the localization stack 314, the HD geospatial database 326, other components of the AV, and other data sources (e.g., the data center 350, the client computing device 370, third party data sources, etc.). The perception stack 312 can detect and classify objects and determine their current locations, speeds, directions, and the like. In addition, the perception stack 312 can determine the free space around the AV 302 (e.g., to maintain a safe distance from other objects, change lanes, park the AV, etc.). The perception stack 312 can identify environmental uncertainties, such as where to look for moving objects, flag areas that may be obscured or blocked from view, and so forth. In some examples, an output of the perception stack 312 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 314 can determine the AV's position and orientation (pose) using different methods from multiple systems (e.g., GPS, IMUs, cameras, LIDAR, RADAR, ultrasonic sensors, the HD geospatial database 326, etc.). For example, in some cases, the AV 302 can compare sensor data captured in real-time by the sensor systems 304-308 to data in the HD geospatial database 326 to determine its precise (e.g., accurate to the order of a few centimeters or less) position and orientation. The AV 302 can focus its search based on sensor data from one or more first sensor systems (e.g., GPS) by matching sensor data from one or more second sensor systems (e.g., LIDAR). If the mapping and localization information from one system is unavailable, the AV 302 can use mapping and localization information from a redundant system and/or from remote data sources.

Prediction stack 316 can receive information from the localization stack 314 and objects identified by the perception stack 312 and predict a future path for the objects. In some examples, the prediction stack 316 can output several likely paths that an object is predicted to take along with a probability associated with each path. For each predicted path, the prediction stack 316 can also output a range of points along the path corresponding to a predicted location of the object along the path at future time intervals along with an expected error value for each of the points that indicates a probabilistic deviation from that point.

Planning stack 318 can determine how to maneuver or operate the AV 302 safely and efficiently in its environment. For example, the planning stack 318 can receive the location, speed, and direction of the AV 302, geospatial data, data regarding objects sharing the road with the AV 302 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 302 from one point to another and outputs from the perception stack 312, localization stack 314, and prediction stack 316. The planning stack 318 can determine multiple sets of one or more mechanical operations that the AV 302 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 318 can select from multiple backup plans to carry out. For example, while preparing to change lanes to turn right at an intersection, another vehicle may aggressively cut into the destination lane, making the lane change unsafe. The planning stack 318 could have already determined an alternative plan for such an event. Upon its occurrence, it could help direct the AV 302 to go around the block instead of blocking a current lane while waiting for an opening to change lanes.

Control stack 322 can manage the operation of the vehicle propulsion system 330, the braking system 332, the steering system 334, the safety system 336, and the cabin system 338. The control stack 322 can receive sensor signals from the sensor systems 304-308 as well as communicate with other stacks or components of the local computing device 310 or a remote system (e.g., the data center 350) to effectuate operation of the AV 302. For example, the control stack 322 can implement the final path or actions from the multiple paths or actions provided by the planning stack 318. This can involve turning the routes and decisions from the planning stack 318 into commands for the actuators that control the AV's steering, throttle, brake, and drive unit.

Communications stack 320 can transmit and receive signals between the various stacks and other components of the AV 302 and between the AV 302, the data center 350, the client computing device 370, and other remote systems. The communications stack 320 can enable the local computing device 310 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 320 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 326 can store HD maps and related data of the streets upon which the AV 302 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls layer can include geospatial information of traffic signal lights, traffic signs, and other road objects and related attributes.

AV operational database 324 can store raw AV data generated by the sensor systems 304-308, stacks 312-322, and other components of the AV 302 and/or data received by the AV 302 from remote systems (e.g., the data center 350, the client computing device 370, etc.). In some examples, the raw AV data can include HD LIDAR point cloud data, image data, RADAR data, GPS data, and other sensor data that the data center 350 can use for creating or updating AV geospatial data or for creating simulations of situations encountered by AV 302 for future testing or training of various machine learning algorithms that are incorporated in the local computing device 310.

Data center 350 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 350 can include one or more computing devices remote to the local computing device 310 for managing a fleet of AVs and AV-related services. For example, in addition to managing the AV 302, the data center 350 may also support a ride-hailing service (e.g., a ridesharing service), a delivery service, a remote/roadside assistance service, street services (e.g., street mapping, street patrol, street cleaning, street metering, parking reservation, etc.), and the like.

Data center 350 can send and receive various signals to and from the AV 302 and the client computing device 370. These signals can include sensor data captured by the sensor systems 304-308, roadside assistance requests, software updates, ride-hailing/ridesharing pick-up and drop-off instructions, and so forth. In this example, the data center 350 includes a data management platform 352, an Artificial Intelligence/Machine Learning (AI/ML) platform 354, a simulation platform 356, a remote assistance platform 358, and a ride-hailing platform 360, and a map management platform 362, among other systems.

Data management platform 352 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of data center 350 can access data stored by the data management platform 352 to provide their respective services.

The AI/ML platform 354 can provide the infrastructure for training and evaluating machine learning algorithms for operating the AV 302, the simulation platform 356, the remote assistance platform 358, the ride-hailing platform 360, the map management platform 362, and other platforms and systems. Using the AI/ML platform 354, data scientists can prepare data sets from the data management platform 352; select, design, and train machine learning models; evaluate, refine, and deploy the models; maintain, monitor, and retrain the models; and so on.

Simulation platform 356 can enable testing and validation of the algorithms, machine learning models, neural networks, and other development efforts for the AV 302, the remote assistance platform 358, the ride-hailing platform 360, the map management platform 362, and other platforms and systems. Simulation platform 356 can replicate a variety of driving environments and/or reproduce real-world scenarios from data captured by the AV 302, including rendering geospatial information and road infrastructure (e.g., streets, lanes, crosswalks, traffic lights, stop signs, etc.) obtained from a cartography platform (e.g., map management platform 362); modeling the behavior of other vehicles, bicycles, pedestrians, and other dynamic elements; simulating inclement weather conditions, different traffic scenarios; and so on.

Remote assistance platform 358 can generate and transmit instructions regarding the operation of the AV 302. For example, in response to an output of the AI/ML platform 354 or other system of the data center 350, the remote assistance platform 358 can prepare instructions for one or more stacks or other components of the AV 302.

Ride-hailing platform 360 can interact with a customer of a ride-hailing service via a ride-hailing application 372 executing on the client computing device 370. The client computing device 370 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 372. The client computing device 370 can be a customer's mobile computing device or a computing device integrated with the AV 302 (e.g., the local computing device 310). The ride-hailing platform 360 can receive requests to pick up or drop off from the ride-hailing application 372 and dispatch the AV 302 for the trip.

Map management platform 362 can provide a set of tools for the manipulation and management of geographic and spatial (geospatial) and related attribute data. The data management platform 352 can receive LIDAR point cloud data, image data (e.g., still image, video, etc.), RADAR data, GPS data, and other sensor data (e.g., raw data) from one or more AVs 302, Unmanned Aerial Vehicles (UAVs), satellites, third-party mapping services, and other sources of geospatially referenced data. The raw data can be processed, and map management platform 362 can render base representations (e.g., tiles (2D), bounding volumes (3D), etc.) of the AV geospatial data to enable users to view, query, label, edit, and otherwise interact with the data. Map management platform 362 can manage workflows and tasks for operating on the AV geospatial data. Map management platform 362 can control access to the AV geospatial data, including granting or limiting access to the AV geospatial data based on user-based, role-based, group-based, task-based, and other attribute-based access control mechanisms. Map management platform 362 can provide version control for the AV geospatial data, such as to track specific changes that (human or machine) map editors have made to the data and to revert changes when necessary. Map management platform 362 can administer release management of the AV geospatial data, including distributing suitable iterations of the data to different users, computing devices, AVs, and other consumers of HD maps. Map management platform 362 can provide analytics regarding the AV geospatial data and related data, such as to generate insights relating to the throughput and quality of mapping tasks.

In some embodiments, the map viewing services of map management platform 362 can be modularized and deployed as part of one or more of the platforms and systems of the data center 350. For example, the AI/ML platform 354 may incorporate the map viewing services for visualizing the effectiveness of various object detection or object classification models, the simulation platform 356 may incorporate the map viewing services for recreating and visualizing certain driving scenarios, the remote assistance platform 358 may incorporate the map viewing services for replaying traffic incidents to facilitate and coordinate aid, the ride-hailing platform 360 may incorporate the map viewing services into the client application 372 to enable passengers to view the AV 302 in transit en route to a pick-up or drop-off location, and so on.

While the autonomous vehicle 302, the local computing device 310, and the autonomous vehicle environment 300 are shown to include certain systems and components, one of ordinary skill will appreciate that the autonomous vehicle 302, the local computing device 310, and/or the autonomous vehicle environment 300 can include more or fewer systems and/or components than those shown in FIG. 3. For example, the autonomous vehicle 302 can include other services than those shown in FIG. 3 and the local computing device 310 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 3.

With reference to certain embodiments of the systems and methods disclosed herein, the data center 350 comprises a site controller (not shown) that manages the parking of AVs in a parking area, e.g., a parking lot, a service area, or a support site for the maintenance, servicing, and storage of AVs. In certain embodiments, the site controller is provided as a software service running on a processor, e.g., a central server with associated memory storage, co-located with other functions of the data center 350. In certain embodiments, the site controller is provided as a standalone hardware system that comprises a processor and a memory and is located at a separate location, e.g., a parking area managed by the site controller. In either embodiment, the memory comprises one or more of instructions that, when loaded into the processor and executed, cause the processor to execute the methods of managing the site as disclosed herein.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

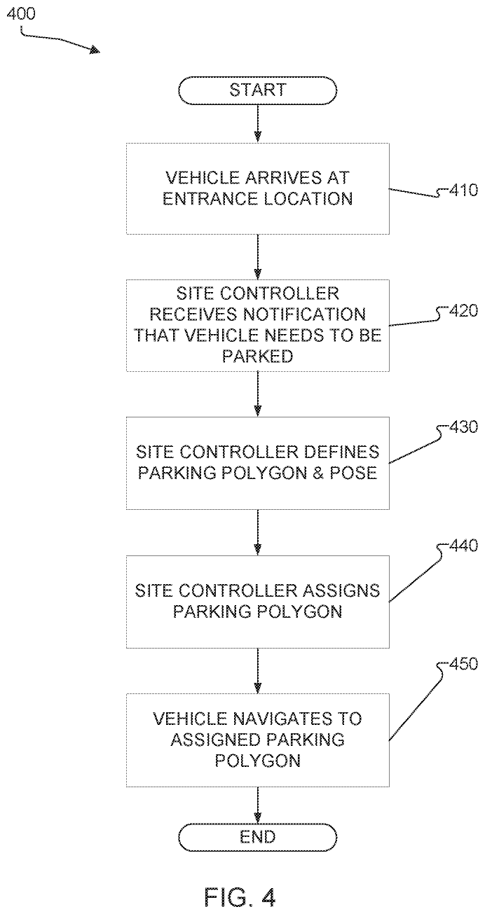

FIG. 4 illustrates an exemplary workflow 400 for managing parking of an AV, according to some aspects of the disclosed technology. In this workflow 400, a site controller implements the software that manages the parking of AVs in a parking lot. A virtual model of the physical parking lot, including parking polygons associated with the parking spaces and travel paths associated with the aisles, has been created and stored in the memory of the site controller.

The workflow begins when an AV arrives at an entrance location of the parking lot (or parking depot) in step 410. In this example, the entrance location is a defined physical space accessible by an AV without prior interaction with the site controller, e.g., outside a rising-arm barrier at the entrance to the parking lot. This physical location is replicated in the virtual model as an entrance polygon. The arrival of the AV triggers a notification in step 420 of the site controller that the AV needs to be parked in the parking lot. In certain embodiments, the notification comprises information associated with the AV, e.g., the minimum size of a parking polygon required to park this particular AV. Depending on the desired implementation, the parking controller may be automatically notified of the AV's parking need, e.g., by a communications system associated with the AV. In other implementations, the site controller may be configured to automatically detect arrival of the AV, and to determine or infer the parking requirements of the arriving AV.

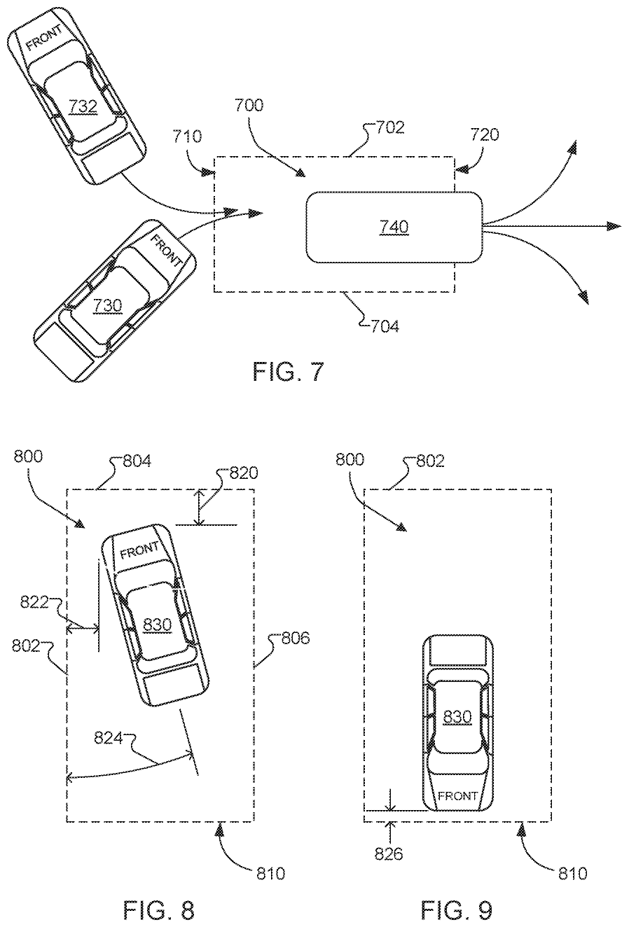

In Step 430, the site controller selects a particular parking polygon associated with a parking space in the parking area. In some aspects, the site controller can also determines the desired pose of the vehicle in the selected parking polygon (discussed further with respect to FIGS. 8-9). In certain embodiments, this determination is based on one or more of a turning radius of the AV and/or other performance aspects of the AV, the location of a charging port on the AV and/or other physical AV attributes, including but not limited to whether the parking polygon is a “thru” polygon (discussed further with respect to FIG. 7) or other physical aspect of the parking lot, physical obstructions in the parking space (annotated as attributes of the parking polygon in the virtual model), and/or potential future movement to a charging station or other future operations related to the AV.

In other aspects, one or more optional poses of the AV may be associated with the parking polygon selected by the site controller. In such approaches, the AV may select from a number of available poses associated with the assigned polygon. For example, a free space planner of the AV may be used to determine an optimal parking pose for a given parking polygon assignment, e.g., based on servicing objectives of the AV and/or based on space constraints associated with optional poses associated with a given polygon. In certain embodiments, the site controller determines whether a particular travel path is required to enable the AV to park in the designated parking polygon within the desired pose.

The site controller assigns the selected parking polygon to the AV at the entrance location in step 440. In certain embodiments, this step comprises sending a message to the AV with the identification of the parking polygon associated with the intended physical parking space and the desired pose. In some approaches, this step can include providing a portion of the virtual model of the parking area to the AV. In other approaches, the site controller may provide information identifying a parking polygon that has already been stored (or is already available to) a computing system of the AV. In such approaches, the site controller may identify a parking polygon from among a multitude of parking polygons that are stored by the AV, such as by identifying the assigned parking polygon on an HD map accessible by the AV. In certain embodiments, the local computing device 310 of the AV selects a path from the current location of the AV in the virtual model to the assigned parking polygon. In certain embodiments, the message from the site controller to the AV includes the recommended path.

Upon receipt of a command to proceed in step 450, the AV navigates autonomously from the entrance polygon to the assigned parking polygon. The workflow terminates when the AV is parked in the assigned parking polygon according to the defined pose.

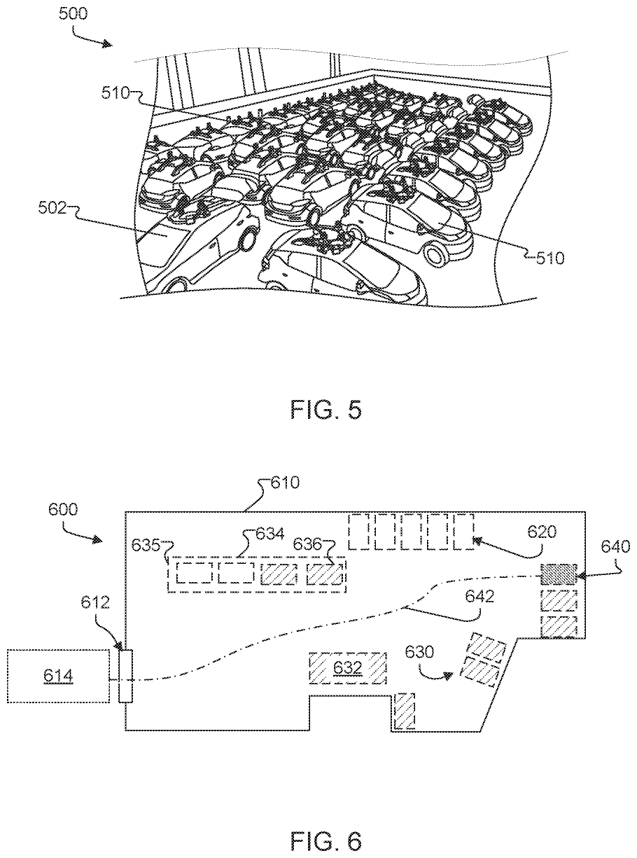

FIG. 5 depicts an exemplary parking area 500 with dynamically defined parking spaces, according to some examples of the present disclosure. In this depiction, a plurality of AVs 502 are parked. There are a row of electrical charging stations 510 disposed along a perimeter of the parking area 500. In certain embodiments, there are statically defined parking spaces proximate to each charging station 510 to enable an AV to be parked within range of the charging cables of a charging station 510. The remaining portion of the parking area does not have statically defined parking spaces.

FIG. 6 illustrates a virtual model 600 of a parking area with dynamically defined parking spaces, according to some examples of the present disclosure. The virtual model 600 includes a perimeter 610 that defines the available parking area. In certain embodiments, the virtual model 600 includes one or more of an entrance 612 and an entrance polygon 614. In certain embodiment, statically defined parking polygons 620 are defined, e.g., proximate to charging stations (not shown). In certain embodiments, the virtual model 600 includes occupied polygons 630 within which AVs are currently parked. Each polygon has associated attributes, e.g., the length and width. Parking polygon 632, for example, contains a larger AV than the standard parking polygons shown elsewhere in the virtual model 600.

Parking polygon 640 is the parking polygon selected for an incoming AV (not shown), for example by a site controller. The location of the selected parking polygon is defined in the virtual model. In certain embodiments, the site controller determines a recommended travel path 642 from the entrance polygon 614 to the selected parking polygon 640.

In certain embodiments, a parking queue 634 is defined by the site controller, for example to queue AVs for recharging, with an entrance 635. In certain embodiments, the parking queue 634 is dynamically defined with a capacity and configuration sufficient to meet the near-term needs for queuing AVs. In certain embodiments, the parking queue 634 is statically defined. In certain embodiments, the site controller assigns the parking queue to the AV as its parking polygon and provides information associated with the parking queue, e.g., the location of the entrance, the length and width of the queue, and definition of parking polygons within the queue.

The AV responds to the instructions received from the site controller by navigating according to the virtual model to the assigned parking polygon. In certain embodiments, the local computing device of the AV determines a travel path from the current location of the AV to the location of the assigned parking polygon or the location of the entrance to the assigned parking queue entrance. In certain embodiments, the AV receives a recommended travel path from the site controller. In certain embodiments, the AV navigation is constrained by boundaries or other delimiters provided by the site controller, e.g., as part of the virtual model of the parking lot.

In certain embodiments where the AV is assigned to parking queue 634, the AV autonomously advances within the queue 634 until it reaches the lead parking polygon 636. In certain embodiments, the AV notifies the site controller that it is at the front of the queue 634 and ready to move to an available charger. In certain embodiments, the AV notifies the site controller upon one or more of the intermediate advances in the queue. In certain embodiments, the AV does not autonomously move between parking polygons and moves only upon an instruction from the site controller that identifies the new parking polygon.

In certain embodiments, the AV can notify the site controller of the need to park in the parking area in advance of arriving at the entrance location of the parking area. The site controller can define and assign a parking polygon and provide the AV with instructions that comprise one or more of the virtual model of the parking area, the location and configuration of the assigned parking polygon, and an access token to be provided upon arrival at the entrance location to gain access to the parking area. In certain embodiments, the assigned parking polygon is a dynamic location within a larger defined space, e.g., the AV is to enter a linear queue of vehicles that may have AVs already parked in the queue wherein the AV moves as far forward in the queue as possible until within a defined separation from the rearmost AV in the queue.

FIG. 7 illustrates attributes of a parking polygon 700, according to some examples of the present disclosure. A parking polygon for a particular AV is inherently larger than the AV such that the AV can be positioned completely within the boundaries of the parking polygon.

Parking polygon 700 has at least one portal, e.g., “entrance” 710, through which AVs may enter and exit the parking polygon 700. AV 730 is shown entering the parking polygon 700 front first, while AV 732 is shown backing into the parking polygon 700. The choice of how to enter the parking polygon 700 is based in part on the desired pose of the vehicle once parked in parking polygon 700 (discussed in further detail with respect to FIGS. 8-9).

In certain embodiments, parking polygon 700 has a second portal through which AVs may enter and leave, e.g., “exit” 720. AV 740, which may be facing either entrance 710 or exit 720 depending on whether the AV drove forward (AV 730) or backed (AV 732) into entrance 710, is shown existing through exit 720.

In certain embodiments, a site controller manages parking of AVs in the parking area. In certain embodiments, this capability is provided by elements of a data center, e.g., data center 350 shown in FIG. 3. In certain embodiments, the site controller system is implemented as a stand-alone system that may be disposed local to the parking area or remote from the parking area. In certain embodiments, the stand-alone system comprises one or more of a processor and a memory. In certain embodiments, the memory comprises one or more of the virtual model and instructions that cause the processor to execute the disclosed methods. In certain embodiments, the stand-alone system is coupled to a remote system that replicates the functions of the stand-alone system. In certain embodiments, the stand-alone system is primary and the remote system is a back-up that manages the parking of AVs when the stand-alone system is not available. In certain embodiments, the remote system is primary and the stand-alone system is the back-up that manages the parking of AVs when the remote system is not available.

In certain embodiments, the site controller may define the parking polygon 700 as having certain boundaries that are impassible. For example, the top boundary 702 and the bottom boundary 704 of parking polygon 700 are defined as impassable while the entrance 710 and exit 720 are inherently passable. Reasons for defining a boundary as impassable include, but are not limited to, a previously defined adjacent parking polygon, a physical barrier in the parking lot or a physical object replicated in the virtual model at a location adjacent to the boundary, or a functional rule of the site controller.

FIGS. 8-9 illustrate attributes of pose of a vehicle within a parking polygon, according to some examples of the present disclosure. In these figures, the size of the parking polygon 800 is oversized compared to the AV 830 in order to enhance the clarity of the aspects discussed herein.

FIG. 8 illustrates a pose of an AV 830 in the parking polygon 800 that has a boundary comprising sides 802, 804, and 806 with an entrance 810. A desired parking pose has been defined for the position and orientation of the AV 830 within the parking polygon 800. In the example shown in FIG. 8, the desired pose has the AV 830 facing inward, with respect to entrance 810, into the parking polygon 800 with separation 820 from boundary 804 and separation 822 from boundary 802. In certain embodiments, the separations are defined as minimum distances. In certain embodiments the separations are defined as a range, i.e., minimum and maximum distances. In certain embodiments, a minimum separation may be defined for all boundaries, e.g., to ensure the AV is within the parking polygon 800. In certain embodiments, the pose has an angle 824 defined as one or a minimum, a maximum, or a range, e.g., zero degrees plus/minus five degrees.

In certain embodiments, the desired pose provided to the AV by the site controller is a factor in selection of a travel path by the AV or by the site controller. For example, a pose such as shown in FIG. 8 would require that the AV 830 enter parking polygon 800 by driving front-forward through entrance 810. In an embodiment where parking polygon 800 is a “thru space” and boundary 804 is a portal, e.g., an exit, AV 830 could achieve the same parking pose by backing into parking polygon 800 through portal 804.

FIG. 9 depicts the same parking polygon 800 with AV 830 in a different pose. In this example, the desired pose has the AV 830 facing outward, with respect to entrance 810, from the parking polygon 800. A separation 826 is defined with respect to the entrance, for example to ensure that the AV 830 is fully within the parking polygon 800 and not projecting into an adjacent travel path.

### Aspects of the Invention:

Aspect A: A method of parking an autonomous vehicle (AV), comprising the steps of receiving a notification that the AV needs to be parked in a physical parking area; defining a first parking polygon and a parking pose in a virtual model that corresponds to the physical parking area; assigning the first parking polygon to the AV; and instructing the AV to navigate to the first parking polygon and assume the parking pose within the first parking polygon.

Aspect B: A system for managing parking of an autonomous vehicle (AV), the system comprising a processor and a memory communicatively coupled to the processor and comprising an instruction that, when loaded into the processor and executed, causes the processor to receive a notification that the AV needs to be parked in a physical parking area; define a first parking polygon and a parking pose in a virtual model that corresponds to the physical parking area; assign the first parking polygon to the AV; and instruct the AV to navigate to the first parking polygon and assume the parking pose within the first parking polygon.

Aspect C: A non-transitory computer-readable storage medium comprising an instruction for causing a processor to receive a notification that the AV needs to be parked in a physical parking area; define a first parking polygon and a parking pose in a virtual model that corresponds to the physical parking area; assign the first parking polygon to the AV; and instruct the AV to navigate to the first parking polygon and assume the parking pose within the first parking polygon.

The various aspects and embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method of parking an autonomous vehicle (AV), comprising:
receiving a notification that the AV needs to be parked in a physical parking area;
defining a first parking polygon and a parking pose in a virtual model that corresponds to the physical parking area;
assigning the first parking polygon to the AV; and
instructing the AV to navigate to the first parking polygon and assume the parking pose within the first parking polygon.

2. The method of claim 1, wherein the physical parking area comprises a plurality of predetermined parking spaces, and the virtual model comprises a plurality of predetermined parking polygons that are respectively associated with the plurality of predetermined parking spaces, and wherein defining the first parking polygon further comprises selecting one of the plurality of predetermined parking polygons.

3. The method of claim 2, wherein the virtual model comprises a travel path that provides vehicular access from a current location of the AV in the virtual model to a portion of the predetermined parking polygons.

4. The method of claim 1, wherein the parking area comprises an available area that is suitable for parking the AV, and wherein defining the first parking polygon comprises selecting a portion of the available area.

5. The method of claim 4, wherein the virtual model comprises one or more second parking polygons, and wherein the second parking polygons each have an AV currently parked therein.

6. The method of claim 5, wherein defining the first parking polygon further comprises:
identifying a travel path in the virtual model from a current location of the AV to the first parking polygon; and
instructing the AV comprises providing the travel path to the AV.

7. The method of claim 1, wherein instructing the AV to navigate to the first parking polygon and assume the parking pose within the first parking polygon, further comprises:
providing a portion of the virtual model to the AV.

8. A system for managing parking of an autonomous vehicle (AV), the system comprising:
a processor; and
a memory communicatively coupled to the processor and comprising instructions that, when loaded into the processor and executed, causes the processor to:
receive a notification that the AV needs to be parked in a physical parking area;
define a first parking polygon and a parking pose in a virtual model that corresponds to the physical parking area;
assign the first parking polygon to the AV; and
instruct the AV to navigate to the first parking polygon and assume the parking pose within the first parking polygon.

9. The system of claim 8, wherein the virtual model comprises a plurality of predetermined parking polygons that are respectively associated with a plurality of predetermined parking spaces, and to define the first parking polygon, the processor is further configured to:
select one of the plurality of predetermined parking polygons.

10. The system of claim 9, wherein the virtual model comprises a travel path that provides vehicular access from a current location of the AV in the virtual model to a portion of the predetermined parking polygons.

11. The system of claim 8, wherein the parking area comprises an available area that is suitable for parking the AV, and wherein defining the first parking polygon comprises selecting a portion of the available area.

12. The system of claim 11, wherein the virtual model comprises one or more second parking polygons, and wherein the second parking polygons each have an AV currently parked therein.

13. The system of claim 12, wherein defining the first parking polygon further comprises:
identifying a travel path in the virtual model from a current location of the AV to the first parking polygon; and
instructing the AV comprises providing the travel path to the AV.

14. The system of claim 8, wherein to instruct the AV to navigate to the first parking polygon the processor is further configured to:
provide a portion of the virtual model to the AV.

15. A non-transitory computer-readable storage medium comprising instructions for causing a processor to:
receive a notification that an autonomous vehicle (AV) needs to be parked in a physical parking area;
define a first parking polygon and a parking pose in a virtual model that corresponds to the physical parking area;
assign the first parking polygon to the AV; and
instruct the AV to navigate to the first parking polygon and assume the parking pose within the first parking polygon.

16. The storage medium of claim 15, wherein the physical parking area comprises a plurality of predetermined parking spaces, and the virtual model comprises a plurality of predetermined parking polygons that are respectively associated with the plurality of predetermined parking spaces, and to define the first parking polygon, the instructions are further configured to cause the processor to:
select one of the plurality of predetermined parking polygons.

17. The storage medium of claim 16, wherein the virtual model comprises a travel path that provides vehicular access from a current location of the AV in the virtual model to a portion of the predetermined parking polygons.

18. The storage medium of claim 15, wherein the parking area comprises an available area that is suitable for parking the AV, and defining the first parking polygon comprises selecting a portion of the available area.

19. The storage medium of claim 18, wherein the virtual model comprises one or more second parking polygons, and wherein the second parking polygons each have an AV currently parked therein.

20. The storage medium of claim 19, wherein to define the first parking polygon, the instructions are further configured to cause the processors to:
identify a travel path in the virtual model from a current location of the AV to the first parking polygon; and
instruct the AV comprises providing the travel path to the AV.
